(19) United States
(12) Patent Application Publication
(10) Pub. No.: US 2006/0103141 A1
(43) Pub. Date: May 18, 2006

(54) Sliding panel latch

(76) Inventors: Richard E. Schlack, Rising Sun, MD (US); D. Dale Turner, Honeyoe Falls, NY (US)

Correspondence Address: Ourmazd S. Ojan;Paul & Paul, Suite 2900, Two Thousand Market Street, Philadelphia, PA, 19103, US

(21) Appl. No.: 11/314,583

(22) Filed: Dec. 21, 2005

Related U.S. Application Data
(63) Continuation of application No. 10/434,903, filed on May 9, 2003, now abandoned.
Application No. 10/434,903 is a continuation-in-part of application No. 10/159,890, filed on Jun. 1, 2002, now Pat. No. 6,957,979.
(60) Provisional application No. 60/371,527, filed on Apr. 9, 2002.

(51) Int. Cl. E05C 1/06

(52) U.S. Cl. 292/139

(57) ABSTRACT

A latch for members that move at least in part slidably into a secured position is disclosed. The latch includes a cup adapted for mounting to a member such as a panel, door, cover, or circuit board, means for securing the cup to the member, a sliding member supported by the cup, a first linking member, and a second linking member. The sliding member is slidably movable relative to the cup. The first linking member is pivotally connected to the cup, and the second linking member is pivotally connected to the sliding member. The first and second linking members are pivotally connected to one another. The member to which the latch is mounted moves toward a secured position as the first and second linking members are moved to their respective closed positions while the sliding member is in engagement with a stationary keeper.

### CROSS-REFERENCE TO RELATED APPLICATIONS

This application is a continuation of U.S. patent application Ser. No. 10/434,903, filed on May 9, 2003, which is a continuation-in-part of U.S. patent application Ser. No. 10/159,890, filed on Jun. 1, 2002, which claims the benefit of United States Provisional Application for Patent Ser. No. 60/371,527, filed on Apr. 9, 2002, all of which are incorporated by reference herein in their entirety.

### BACKGROUND OF THE INVENTION

1. Field of the invention

The present invention relates to a latch for releasably securing a first member relative to a second member, wherein the first member moves at least in part slidably relative to the second member in order to move into the secured position.

2. Description of the Prior Art

Latches are used to releasably secure panels, covers, doors, electronic modules, and the like to other structures such as compartments, containers, door frames, other panels, frames, racks, etc. Although many types of latches are known in the art, none offers the advantages of the present invention. The advantages of the present invention will be apparent from the attached description and drawings.

### SUMMARY OF THE INVENTION

The present invention is directed to a latch for use with members that move at least in part slidably into a secured position. The latch includes a cup adapted for mounting to a member such as a panel, door, cover, circuit board, or the like; means for securing the cup to the panel, door, cover, circuit board, or the like; a sliding member supported by the cup; a first linking member; and a second linking member. The sliding member is slidably movable relative to the cup. The first linking member is pivotally connected to the cup, and the second linking member is pivotally connected to the sliding member. The first and second linking members are pivotally connected to one another. The sliding member moves in response to movement of the linking members. The member, such as a panel, door, cover, circuit board, or the like, to which the latch is mounted moves toward a secured position as the first and second linking members are moved to their respective closed positions while the sliding member is in engagement with a stationary keeper.

### BRIEF DESCRIPTION OF THE DRAWINGS

FIG. 1 is a perspective view of the sliding panel latch of the present invention, shown in the open configuration.

FIG. 2 is a perspective view of the sliding panel latch of the present invention, shown in the closed configuration.

FIG. 3 is an environmental view showing the sliding panel latch of the present invention installed in the removable panel of a container with the removable panel in the closed position.

FIG. 4 is an environmental view showing the sliding panel latch of the present invention installed in the removable panel of a container with the removable panel in the released or intermediate position.

FIG. 5A is an environmental view showing the sliding panel latch of the present invention installed in the removable panel of a container with the removable panel in the removed position.

FIG. 5B is a fragmentary detail view showing the portion of the removable panel of FIG. 5A that engages the container so as to prevent the panel from being lifted off without first sliding the panel to the released position.

FIGS. 6-9 are views of the sliding member or slide of the sliding panel latch of the present invention.

FIGS. 10-13 are views of the retainer of the sliding panel latch of the present invention.

FIGS. 14-17 are views of a linking member of the sliding panel latch of the present invention.

FIGS. 18-21 are views of a linking member that also serves as the handle or operating lever of the sliding panel latch of the present invention.

FIGS. 22-25 are views of the cup that serves as the base of the illustrated embodiment of the sliding panel latch of the present invention.

FIGS. 26-29 are views of the complete latch assembly of the illustrated embodiment of the sliding panel latch of the present invention.

FIG. 30 is an elevational front view illustrating the structure of the removable panel around the opening in the panel in which the illustrated embodiment of the sliding panel latch of the present invention can be installed.

FIG. 31 is a perspective view illustrating the structure of the removable panel around the opening in the panel in which the illustrated embodiment of the sliding panel latch of the present invention can be installed.

FIG. 32 is an environmental, side elevation view of the illustrated embodiment of the sliding panel latch of the present invention, shown in the closed configuration.

FIG. 33 is a cross sectional, side elevation view of the illustrated embodiment of the sliding panel latch of the present invention, shown in the closed configuration.

FIG. 34 is a cross sectional view of the illustrated embodiment of the sliding panel latch of the present invention taken through the closed detent legs, showing the latch in the closed configuration.

FIG. 35 is a cross sectional view of the illustrated embodiment of the sliding panel latch of the present invention taken through the open detent legs, showing the latch in the closed configuration.

FIG. 36 is a top plan view of the illustrated embodiment of the sliding panel latch of the present invention, showing the latch in the closed configuration.

FIG. 37 is an environmental, side elevation view of the illustrated embodiment of the sliding panel latch of the present invention, shown in the open configuration.

FIG. 38 is a cross sectional, side elevation view of the illustrated embodiment of the sliding panel latch of the present invention, shown in the open configuration.

FIG. 39 is a cross sectional view of the illustrated embodiment of the sliding panel latch of the present invention taken through the closed detent legs, showing the latch in the open configuration.

FIG. 40 is a cross sectional view of the illustrated embodiment of the sliding panel latch of the present invention taken through the open detent legs, showing the latch in the open configuration.

FIG. 41 is a top plan view of the illustrated embodiment of the sliding panel latch of the present invention, showing the latch in the open configuration.

Similar reference characters denote corresponding features consistently throughout the attached drawings.

### DETAILED DESCRIPTION OF THE PREFERRED EMBODIMENTS

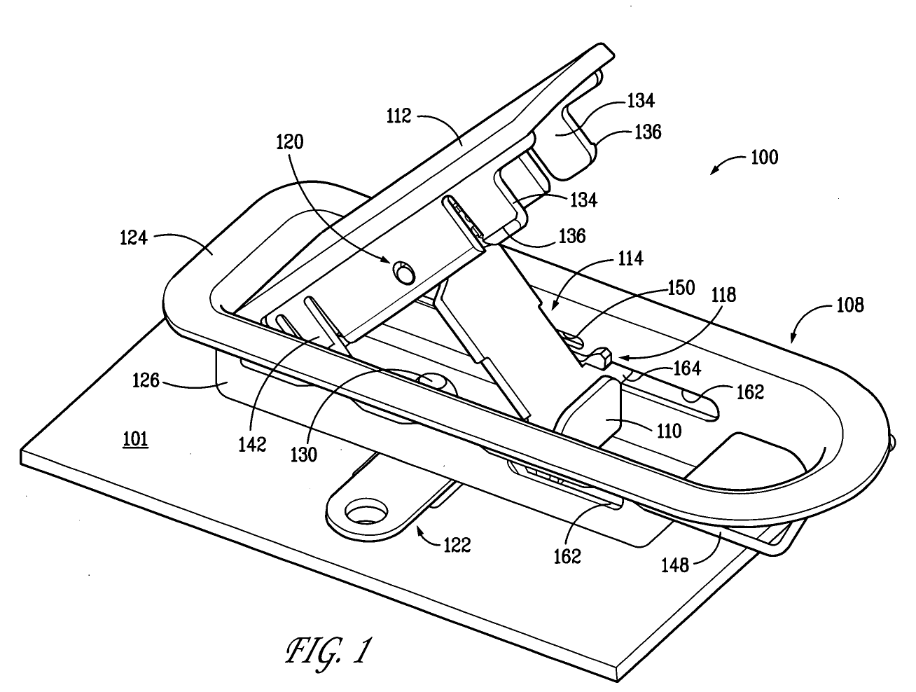

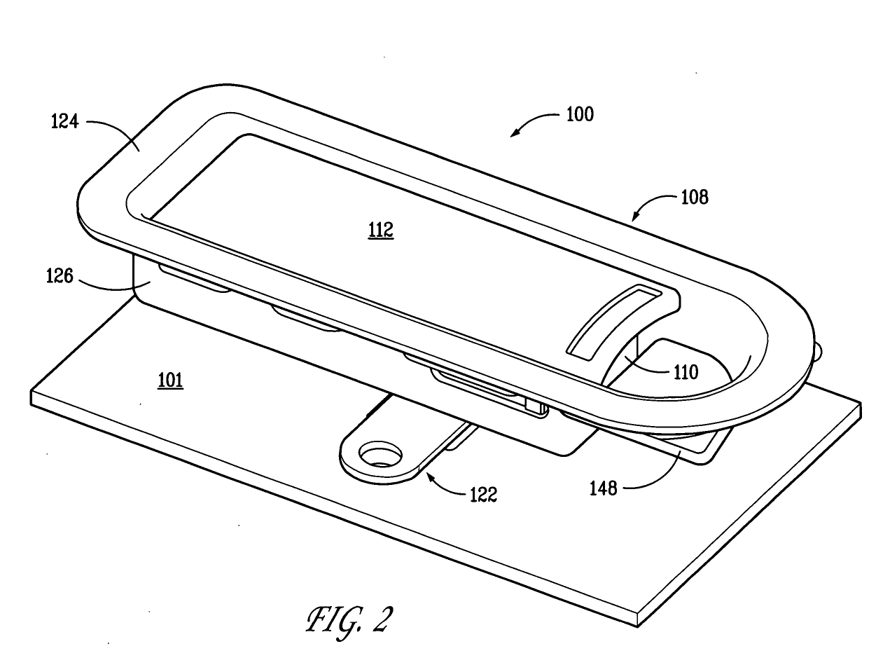

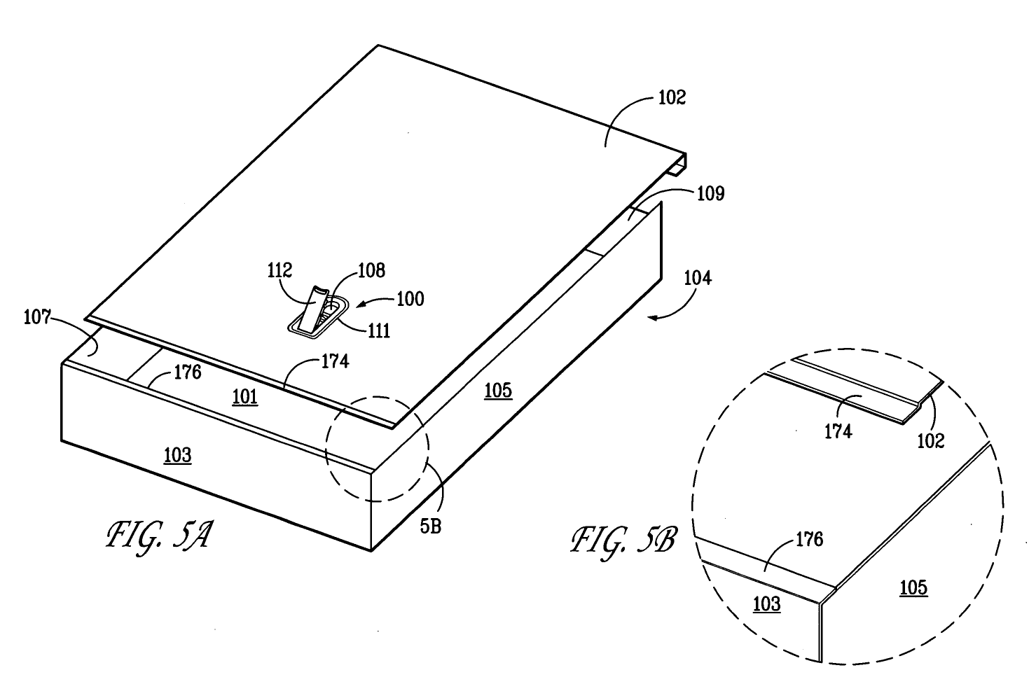

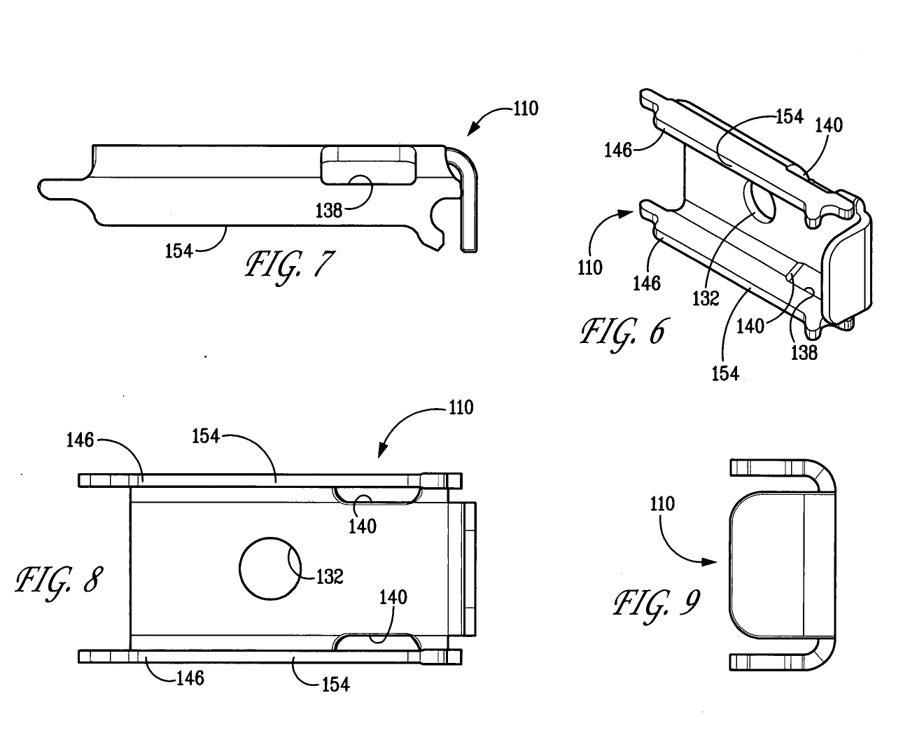

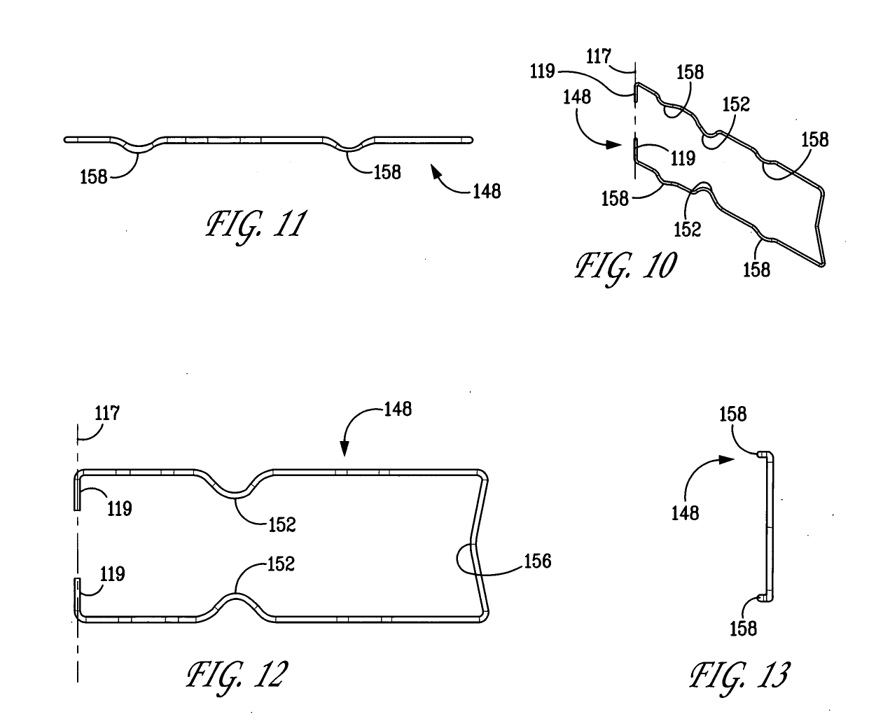

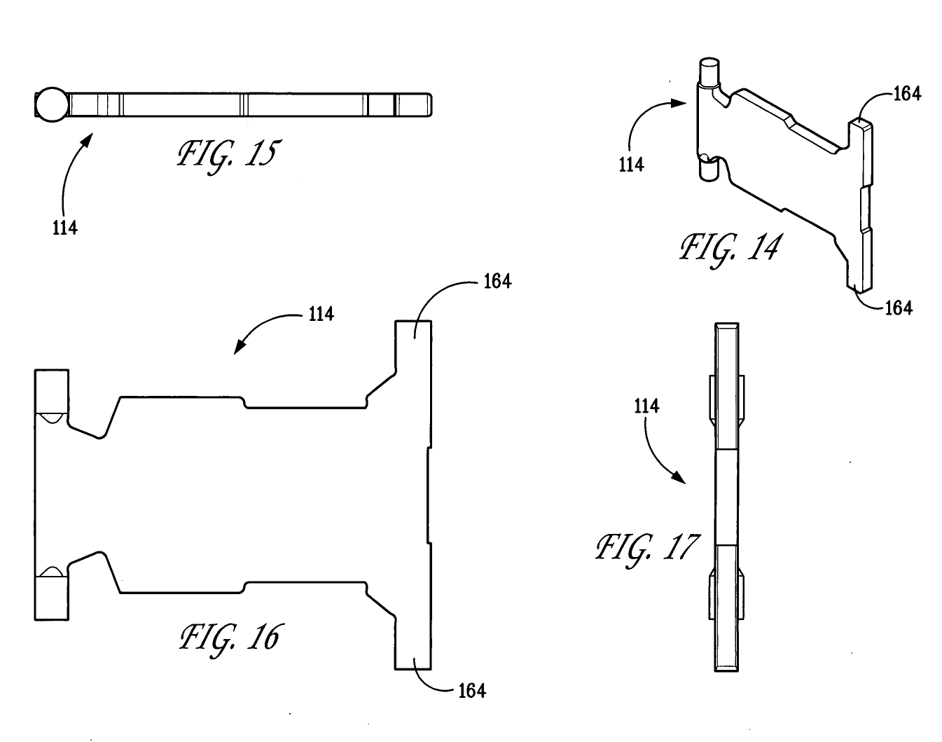

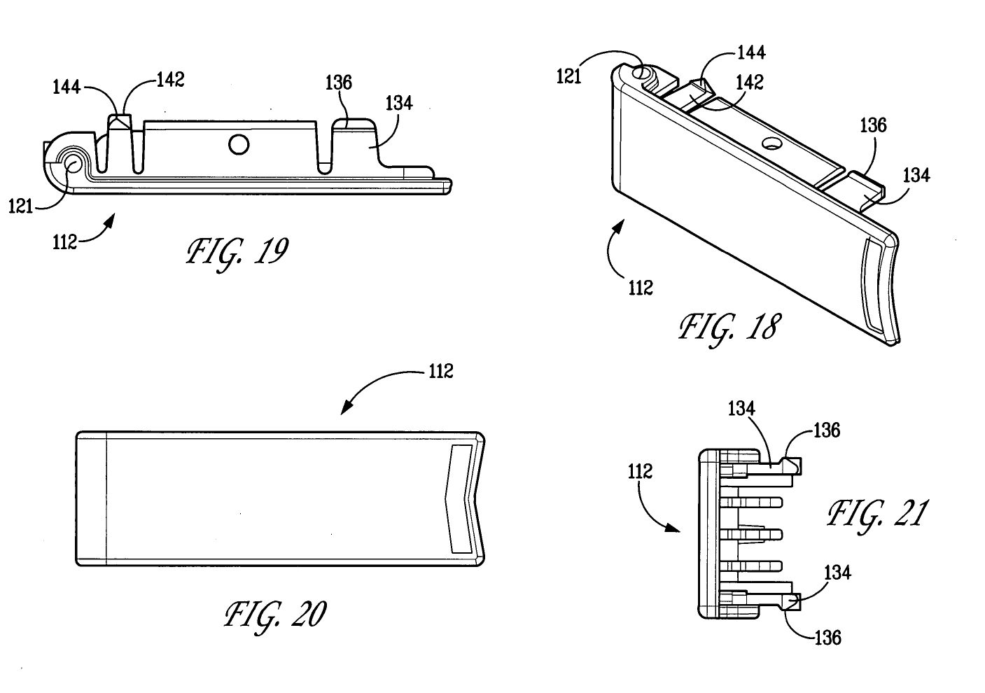

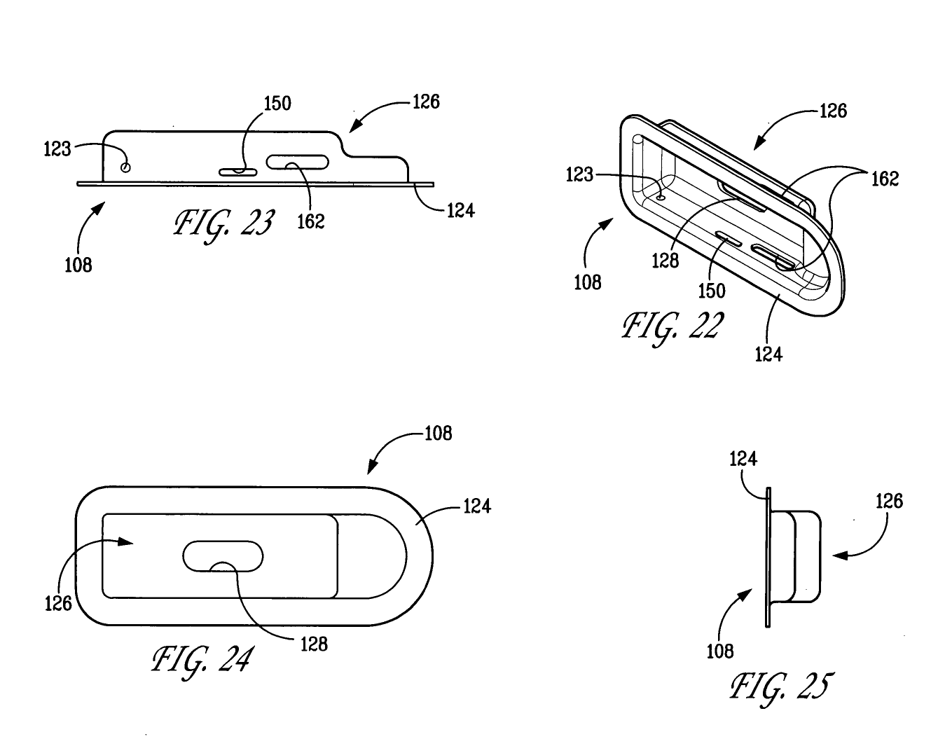

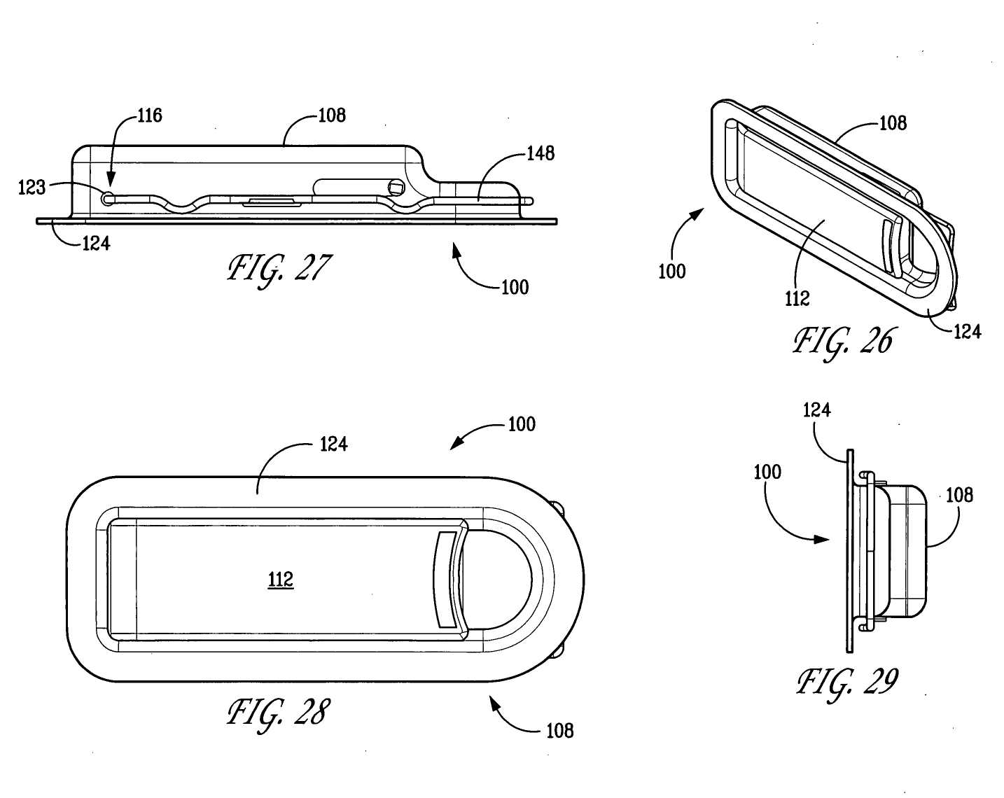

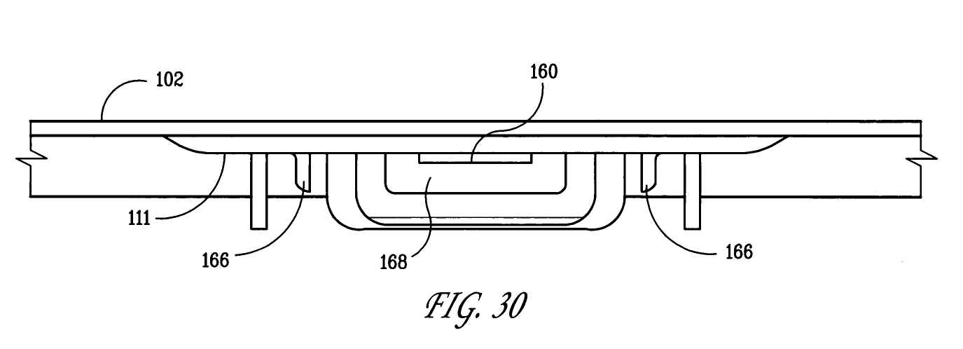

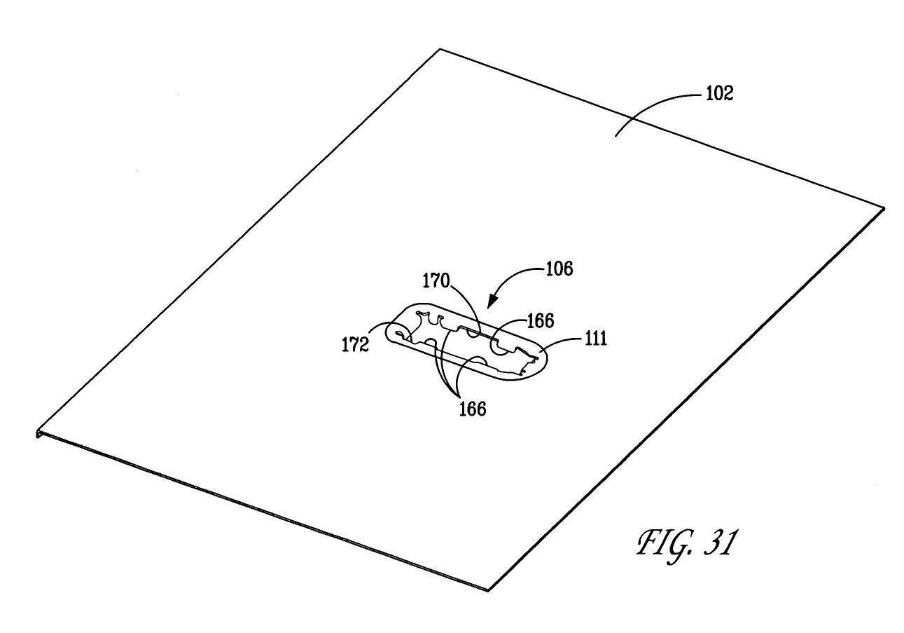

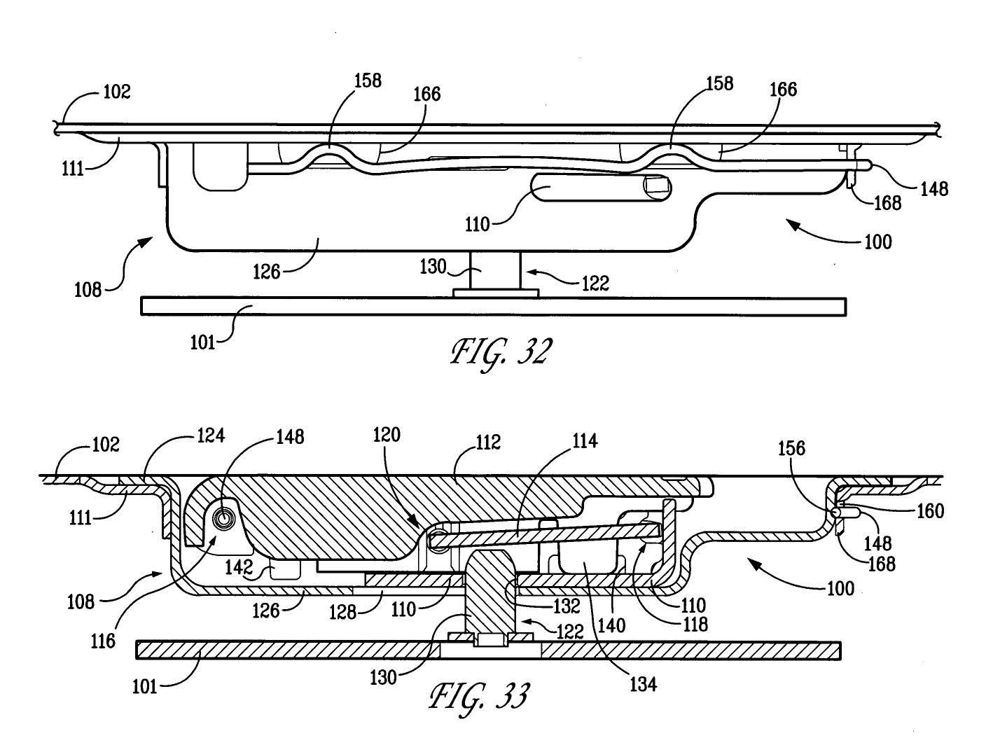

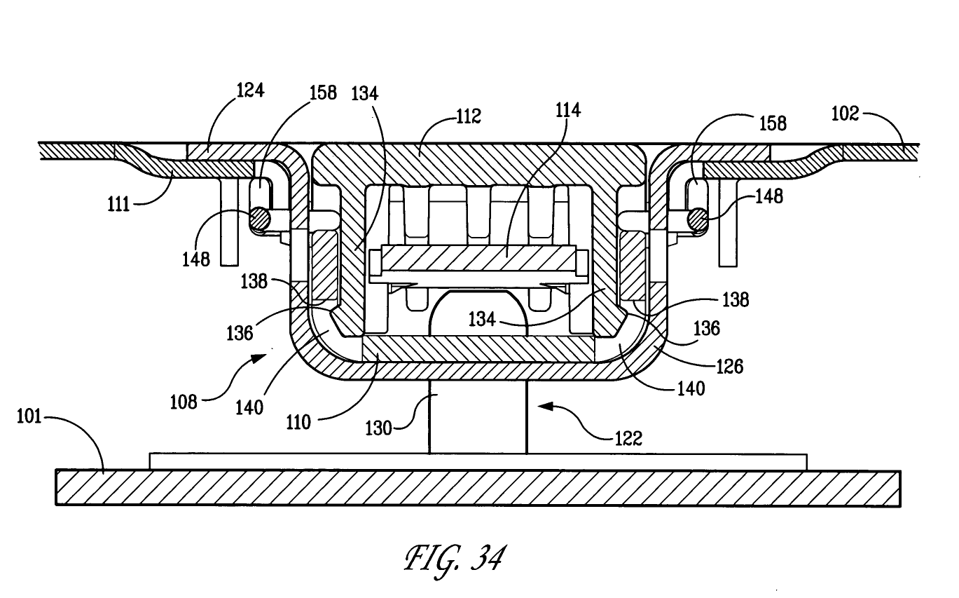

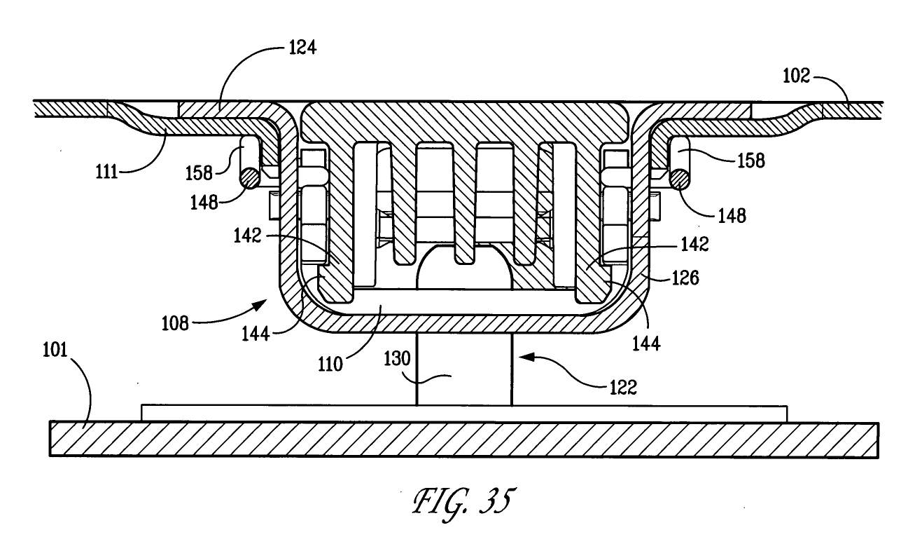

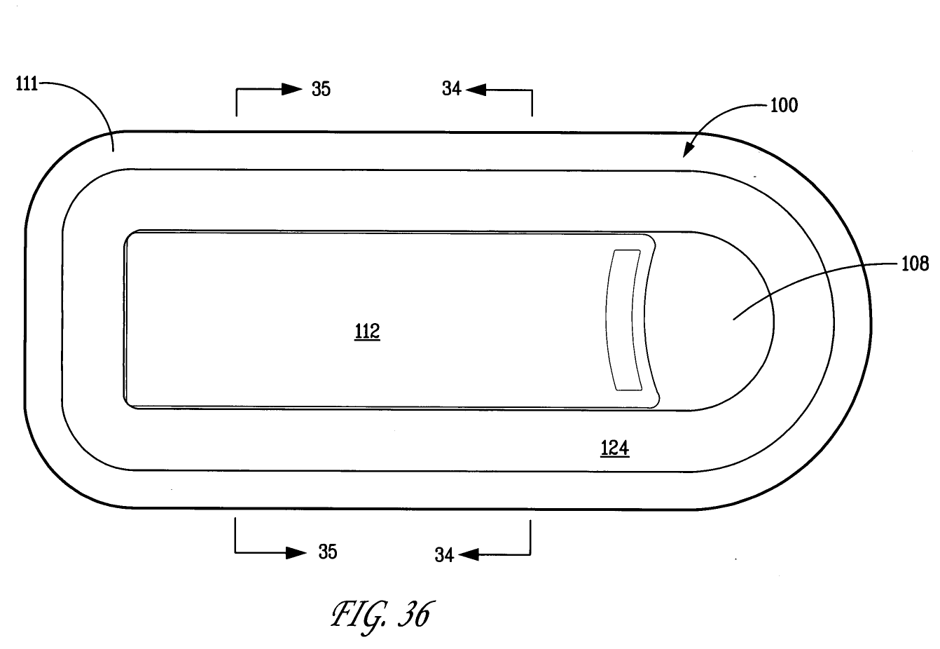

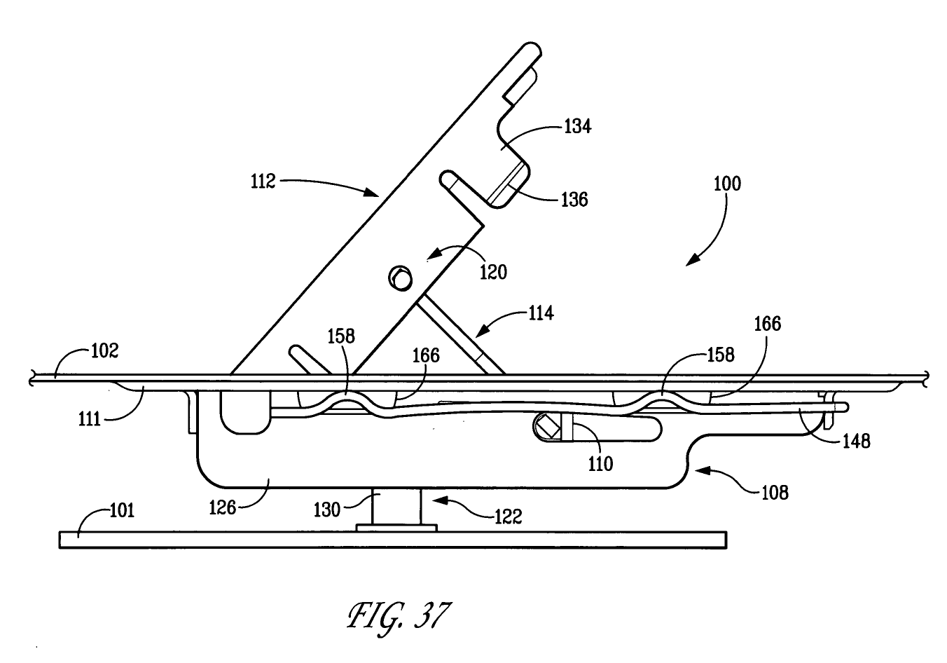

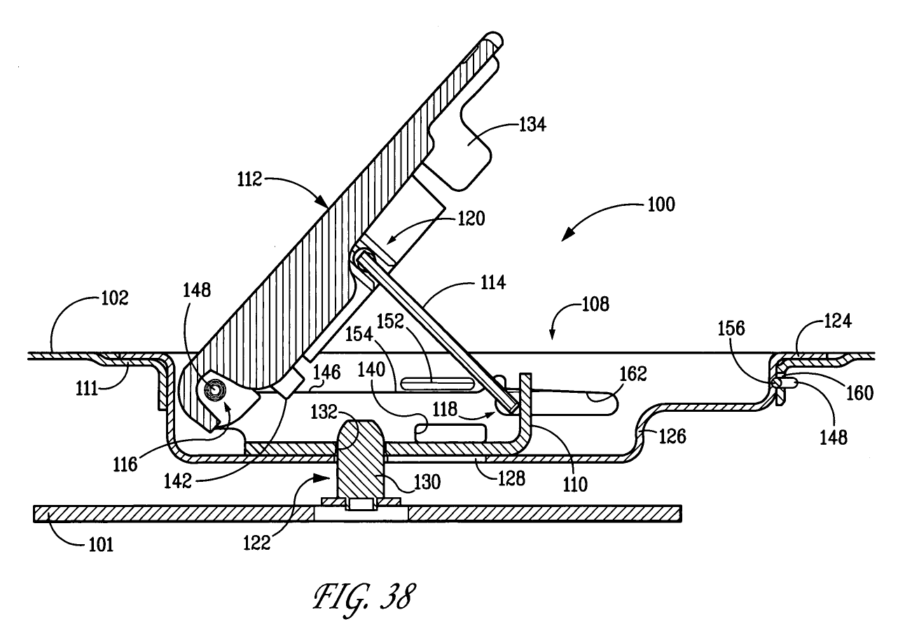

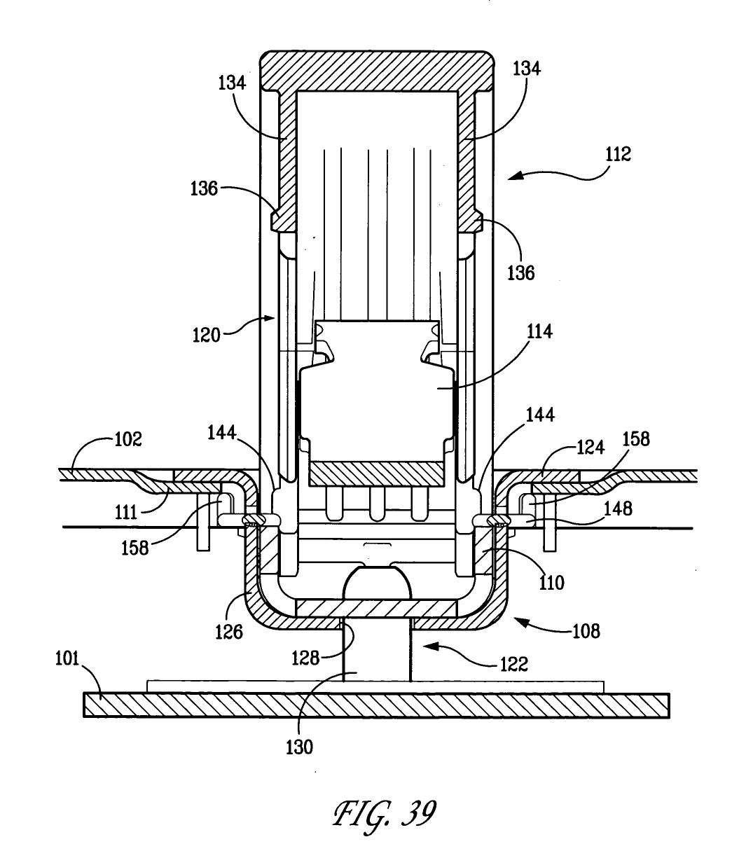

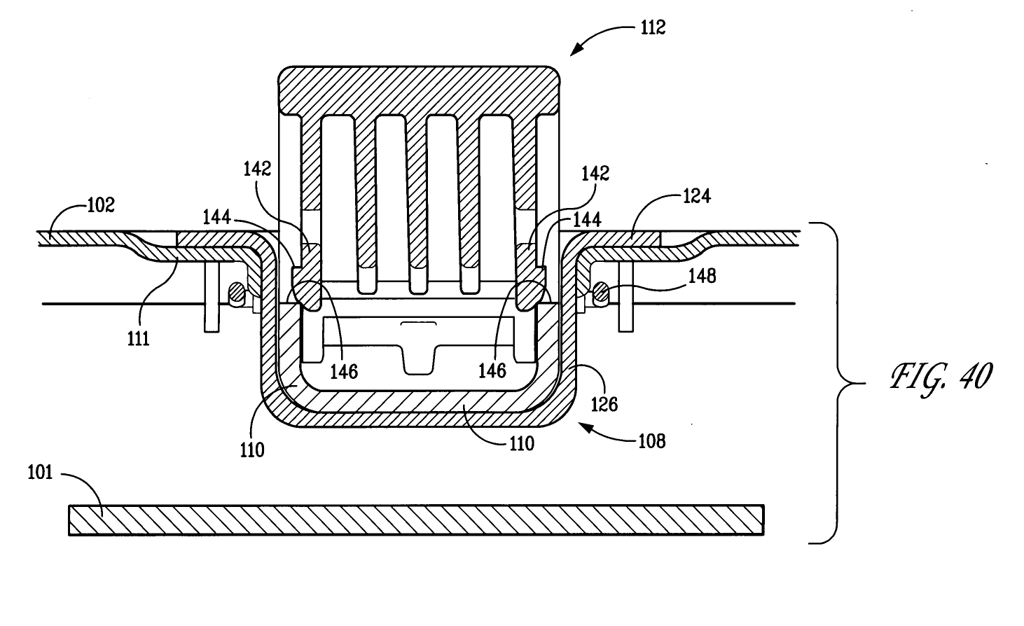

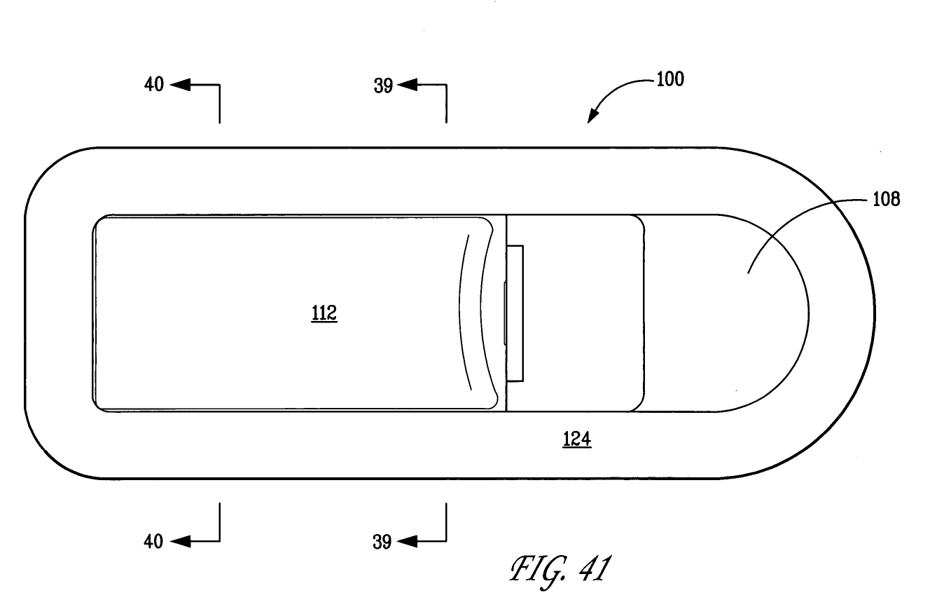

Referring to FIGS. 1-41, the present invention is directed to a latch that is particularly suited for releasably securing a first member relative to a second member, wherein the first member moves at least in part slidably relative to the second member in order to move from the full open position to the fully closed or secured position. An illustrative embodiment 100 of the latch of the present invent is shown in the drawing figures.

In the illustrative embodiment the latch 100 is used to secure the lid or removable panel 102 of a container 104 over the top opening of the container 104. The panel 102 has an opening 106 that permits the installation of the latch 100 to the panel 102. The container 104 has a bottom 101, a front side 103, a left side 105, a right side 107, and a rear side 109. The opening 106 is provided in a portion 111 of the panel 102 that is depressed relative to the remainder of the panel 102. This arrangement advantageously provides for the latch 100 to be flush with the greater portion of the panel 102 when the latch 100 is in the closed configuration. This feature is particularly useful when a plurality of containers 104 are to be stacked or mounted in a rack. The flush mounted feature of the latch 100 is made possible to a large extent by its design which allows for very low profile when the latch is in the closed configuration. The latch 100 can also be mounted in a panel where the opening 106 is not provided in a depression.

The latch 100 is used for securing a first member, in the illustrated case panel 102, in a closed position relative to a second member, in the illustrated case the container 104. The latch 100 includes a base 108 adapted for mounting to the first member 102, means for securing the base 108 to the first member 102, a sliding member 110 movably supported by the base 108, a first linking member 112, and a second linking member 114. The sliding member 110 is slidably movable relative to the base 108 over a range of motion between open and closed positions. The first linking member 112 is pivotally connected to the base 108 at a first pivotal connection 116. The first linking member 112 is pivotally movable between open and closed positions. The second linking member 114 is pivotally connected to the sliding member 110 at a second pivotal connection 118. The second linking member 114 is pivotally connected to the first linking member 112 at a third pivotal connection 120. The second linking member 114 is pivotally movable relative to the sliding member 110 between open and closed positions.

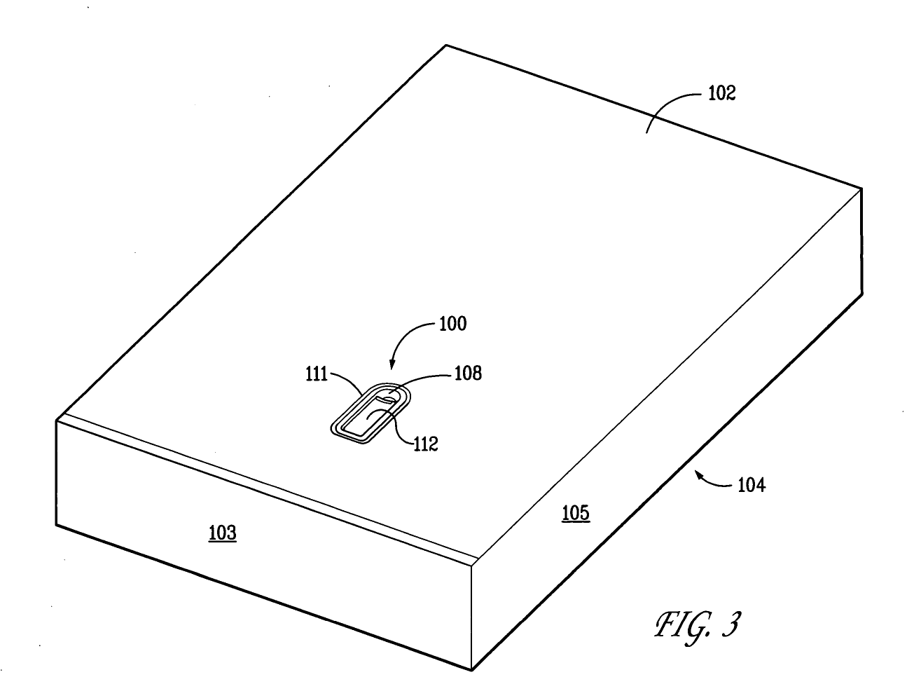

The sliding member 110 moves over at least a portion of its range of motion toward its respective closed position relative to the base 108 responsive to movement of the first and second linking members 112 and 114 toward their respective closed positions. The first member 102 moves toward the secured position illustrated in FIG. 3 in a direction substantially parallel to a direction in which the sliding member 110 moves relative to the base 108, when the base 108 is mounted to the first member 102 and as the sliding member 110 moves toward its closed position relative to the base 108.

The sliding member 110 is adapted for being positioned substantially in a secured position relative to a keeper 122 provided in a fixed positional relationship relative to the second member 104 even as the sliding member 110 moves toward its closed position relative to the base 108 responsive to movement of the first linking member 112 and the second linking member 114 toward their respective closed positions. The positional relationship between the sliding member 110 and the keeper 122 is maintained even as movement of the first member 102 toward its secured position relative to the container 104 is occurring.

In the illustrated embodiment, the base 108 is in the form of a cup adapted for mounting in the opening 106 in the first member 102. The cup 108 has a flange 124 that is engageable with a portion of the first member 102 adjacent the opening 106. The cup 108 also has a tub portion 126. The tub portion 126 has a slot 128, and the keeper pin 130 of the keeper 122 passes through the slot 128 such that the keeper pin 130 can be engaged by the sliding member 110 to thereby provide for movement of the first member 102 toward the secured position of the first member 102 shown in FIG. 3.

The keeper 122 has at least a portion 130 that is in the form of a post or pin, and the sliding member 110 has an opening 132 adapted to receive the post 130, when the latch 100 is mounted to the first member 102 and the first member 102 is positioned relative to the second member 104 as shown in FIG. 4. When the panel or first member 102 is positioned as shown in FIG. 4, the post 130 passes through the slot 128 in the tub portion 126 of the cup 108 and engages the opening 132 in the sliding member 110 and the first member 102 is ready for movement into its secured position shown in FIG. 3.

In the illustrated embodiment, the first linking member 112 has a pair of closed detent legs 134 that at least help to retain the latch 100 in the closed configuration until the latch is forced to the open configuration by a user. Each of the pair of closed detent legs 134 is resilient and has a tip and a detent projection 136 provided within proximity of the tip. The sliding member 110 has a pair of catch surfaces 138 and the detent projection 136 of each of the pair of closed detent legs 134 engages a respective one of the pair of catch surfaces 138 to at least help to retain the latch 100 in the closed configuration until the latch is forced to the open configuration by a user. Each of the pair of catch surfaces 138 is formed by a respective one of a pair of detent slots 140 formed in the sliding member 110.

In the illustrated embodiment, the linking member 112 has a pair of open detent legs 142 that at least help to retain the latch 100 in the open configuration until the latch 100 is forced to the closed configuration by a user. Each of the pair of open detent legs 142 is resilient and has a tip and a detent projection 144 provided within proximity of the tip of each of the pair of open detent legs 142. The sliding member 110 has a pair of open detent surfaces 146 and the detent projection 144 of each of the pair of open detent legs 142 engages a respective one of the pair of open detent surfaces 146 to at least help to retain the latch 100 in the open configuration until the latch 100 is forced to the closed configuration by a user.

In the illustrated embodiment, the first linking member 112 has a middle portion and the third pivotal connection 120 is located within proximity of the middle portion of the first linking member 112 and the first linking member 112 serves as a handle or lever to allow a user to operate the latch 100. Alternatively, the positions of the lever 112 and the link 114 may be reversed such that the lever 112 is pivotally connected to the sliding member 110 while the link 114 is pivotally connected to the cup 108.

In the illustrated embodiment, the means for securing the base or cup 108 to the first member 102 comprises a retainer 148 pivotally supported relative to the cup 108. The retainer 148 is movable between fastened and unfastened positions. The retainer 148 and the flange 124 cooperatively maintain the portion of the first member 102 adjacent the opening 102 intermediate the retainer 148 and the flange 124 to thereby maintain the cup 108 in a mounted position relative to the opening 106 in the first member 102 when the cup 108 is in the mounted position and the retainer 148 is in the fastened position.

The latch 100 further includes means for maintaining the retainer 148 in the fastened position. In the illustrated embodiment, the retainer 148 is a resilient frame-like or brace-like structure pivotally linked to the cup 108. The cup 108 has at least a pair of slots 150 and the retainer 148 has at least a pair of opposing projecting portions 152 that engage respective ones of the pair of slots 150 to retain the retainer 148 in the fastened position. Thus, in the illustrated embodiment, the means for maintaining the retainer 148 in the fastened position includes the pair of slots 150. Each of the pair of opposing projecting portions 152 is approximately U-shaped and is formed by a bend or a bent portion in the wire-frame-like structure of the retainer 148. Although a pair of opposing slots 150 and a pair of corresponding bend portions 152 are preferred, a single slot 150 and a single corresponding bend or projecting portion 152 may also be employed as an alternative.

In the illustrated embodiment, the slots 150 and the projecting portions 152 are arranged such that the pair of opposing projecting portions 152 extend through the pair of slots 150 and at least in part help to guide the sliding member 110 as the sliding member 110 slidably moves relative to the cup 108. The projecting portions 152 limit the movement of the sliding member 110 away from the bottom of the tub portion 126 of the cup 108 by working against the surfaces 154 of the sliding member 110.

In the illustrated embodiment, the retainer 148 is formed by a wire or wire-like structure having bends at various locations along its length to thereby form the resilient frame-like structure illustrated in FIGS. 10-13. As an alternative, the retainer 148 may include at least one projecting portion 158 that extends toward the flange 124 when the retainer 148 is in the fastened position. In the illustrated embodiment four projecting portions 158 are employed. The projecting portions 158 engage the underside of the first member 102 and cooperate at least in part with the flange 124 to maintain the portion of the first member 102 adjacent the opening 106 intermediate the retainer 148 and the flange 124 to thereby maintain the cup 108 in the mounted position relative to the opening 106 when the retainer 148 is in the fastened position. The projecting portions 158 provide a spring force to strongly hold the flange 124 against the panel 102 and thus prevent any play therebetween even as the thickness of the panel 102 is varied within predetermined limits. The projecting portions 158 are formed by approximately V-shaped bends in the retainer 148. Alternatively, the projecting portions 158 may be formed by approximately U-shaped bends.

As an alternative to or in combination with the slots 150 and the projecting portions 152, the retainer 148 may include at least a projecting portion 156 that extends toward the pivot axis of the retainer 148. In the illustrated embodiment the pivot axis 117 of the retainer 148 is essentially coincident with the pivot axis of the lever 112 at the pivotal connection 116. Any solid or hollow shaft placed through the holes 123, provided on each side of the cup 108, and the hole 121 of the lever 112 can be used to pivotally attach the lever 112 to the cup 108. The opposing free ends 119 of the retainer 148 pass through the holes 123 to pivotally attach the retainer 148 to the cup 108 and extend into the hole 121 of the lever 112. The projecting portion 156 is adapted to engage the slot 160 proximate the opening 106 in the first member 102 to retain the retainer 148 in the fastened position. In the illustrated embodiment, the projecting portion 156 is formed by an approximately V-shaped bend in the retainer 148. Alternatively, the projecting portion 156 may be formed by an approximately U-shaped bend.

A further aspect of the present invention is to provide a latch having an operating mechanism that includes at least one projection that moves back and forth as the operating mechanism is operated between the closed and open configurations. The projection engages some portion of the panel 102 when the latch is in the closed configuration to temporarily hold the latch in the mounted position until the retainer is applied. In the illustrated embodiment, the tub portion of the cup 108 is provided with lateral slots 162. The link 114 has projections 164 that extend through the lateral slots 162 and slide along the lateral slots 162 as the sliding member 110 moves relative to the cup 108. The projections 164 extend approximately along the pivot axis of the pivotal connection between the link 114 and the sliding member 110. The panel 102 is provided with at least one tab 166 projecting from the back or interior of the panel proximate the opening 106 in the panel 102. The tab 166 is engaged by the projections 164 when the slide 110 is in the closed position relative to the cup 108 in order to temporarily hold the latch 100 in the mounted position until the retainer 148 is applied.

In the illustrated embodiment, the panel 102 has an opening 106 adapted to receive the cup 108. The panel 102 has an exterior and a back. The panel includes a plurality of tabs 166 projecting from the back of the panel proximate the opening 106. At least one slotted tab 168 projects from the back of the panel proximate the opening 106. The plurality of tabs 166 are positioned adjacent the opening 106 and contact the cup 108 of the latch to thereby provide a larger supporting surface for the cup of the latch when the latch is mounted to the panel. The slotted tab 168 has a slot 160 adapted for engagement by the resilient retainer 148 pivotally connected to the cup 108 of the latch. The opening 106 has a first portion 170 having a first width and a second portion 172 having a second width, the second width being larger than the first width. The portion 172 is provided to accommodate the pivotal attachment of the retainer 148.

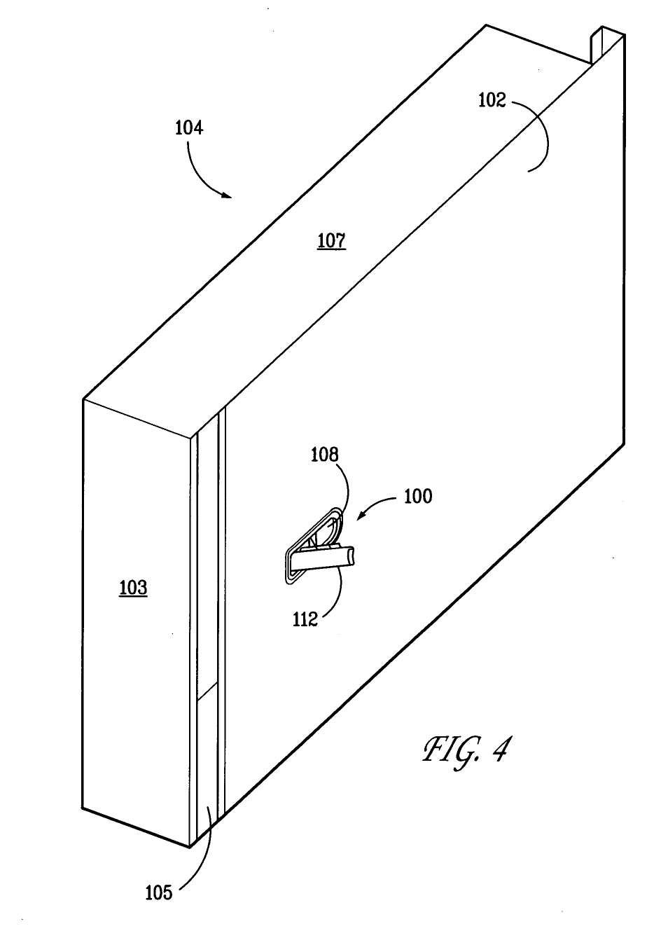

In use, the latch 100 is first mounted to the panel 102. With the panel 102 in the position shown in FIG. 5A, the panel 102 is positioned over the open top of the container 104 as shown in FIG. 4. In this position the slide 110 receives and engages the keeper pin 130 and cannot move relative to the container 104. As the user forces the lever 112 to the closed position, the panel 102 is forced from the position illustrated in FIG. 4 to that illustrated in FIG. 3. In the position illustrated in FIG. 3, the offset lip 174 of the panel 102 moves under the overhang 176 of the container to secure the panel 102 in the closed position illustrated. The panel 102 is removed by reversing this sequence. It is to be understood that the present invention is not limited to the embodiments described above, but encompasses any and all embodiments within the scope of the following claims.

We claim:

1. A latch for use in securing a first member in a secured position, the first member having an opening for mounting the latch thereto and with a portion of the first member being adjacent the opening in the first member, the latch comprising:
a cup adapted for mounting in the opening in the first member, said cup having a flange engageable with the portion of the first member adjacent the opening in the first member; and
a retainer pivotally supported relative to said cup, said retainer being movable between fastened and unfastened positions, said retainer and said flange cooperatively maintaining the portion of the first member adjacent the opening in the first member intermediate said retainer and said flange to thereby maintain said cup in a mounted position relative to the opening in the first member when said cup is in the mounted position and said retainer is in said fastened position.

2. The latch according to claim 1, further comprising means for maintaining said retainer in said fastened position.

3. The latch according to claim 2, wherein said retainer is a resilient frame-like structure pivotally linked to said cup.

4. The latch according to claim 3, wherein said cup has at least one slot and said retainer has at least one projecting portion that engages said at least one slot to retain said retainer in said fastened position, said means for maintaining said retainer in said fastened position comprising said at least one slot.

5. The latch according to claim 4, wherein said at least one projecting portion is approximately U-shaped.

6. The latch according to claim 3, wherein said cup has at least a pair of slots and said retainer has at least a pair of opposing projecting portions that engage respective ones of said at least a pair of slots to retain said retainer in said fastened position, said means for maintaining said retainer in said fastened position comprising said at least a pair of slots.

7. The latch according to claim 6, wherein each of said at least a pair of opposing projecting portions is approximately U-shaped.

8. The latch according to claim 6, further comprising:
an operating mechanism supported by said cup, said operating mechanism including a sliding member slidably movable relative to said cup,
wherein said pair of opposing projecting portions extend through said at least a pair of slots and at least in part help to guide said sliding member as said sliding member slidably moves relative to said cup.

9. The latch according to claim 8, wherein said retainer is formed by a wire having bends at various locations along its length to thereby form said resilient frame-like structure.

10. The latch according to claim 9, wherein said retainer has at least a third projecting portion that extends toward said flange when said retainer is in said fastened position, said third projecting portion engaging the first member and cooperating at least in part with said flange to maintain the portion of the first member adjacent the opening in the first member intermediate said retainer and said flange to thereby maintain said cup in a mounted position relative to the opening in the first member when said cup is in the mounted position and said retainer is in said fastened position.

11. The latch according to claim 10, wherein said third projecting portion is formed by an approximately V-shaped bend in said retainer.

12. The latch according to claim 3, wherein the latch can be used with the first member that has a slot provided proximate the opening in the first member, and wherein said retainer has at least one projecting portion adapted to engage the slot proximate the opening in the first member to retain said retainer in said fastened position, said means for maintaining said retainer in said fastened position comprising said at least said projecting portion.

13. The latch according to claim 12, wherein said retainer pivots about a pivot axis and said projecting portion is approximately V-shaped and projects toward said pivot axis.

14. A latch for use in securing a first member in a secured position relative to a second member with a keeper provided in a fixed positional relationship relative to the second member and with the first member having provided therein an opening with a portion of the first member being adjacent the opening provided in the first member, the latch comprising:
a base adapted for mounting to the first member;
means for securing said base to the first member;
a sliding member movably supported by said base, said sliding member being slidably movable relative to said base over a range of motion between open and closed positions;
a first linking member pivotally connected to said base at a first pivotal connection, said first linking member being pivotally movable between open and closed positions; and
a second linking member pivotally connected to said sliding member at a second pivotal connection, said second linking member being pivotally connected to said first linking member at a third pivotal connection, said second linking member being pivotally movable relative to said sliding member between open and closed positions,
wherein said sliding member moves over at least a portion of said range of motion toward said closed position of said sliding member relative to said base responsive to movement of said first and second linking members toward their respective closed positions, and
wherein the first member moves toward a secured position in a direction substantially parallel to a direction in which said sliding member moves relative to said base as said sliding member moves toward said closed position of said sliding member relative to said base when said base is mounted to the first member,
wherein said sliding member is adapted for being positioned substantially in a secured position relative to the keeper even as said sliding member moves toward said closed position of said sliding member relative to said base responsive to movement of said first and second linking members toward their respective closed positions and even as movement of the first member toward the secured position thereof is occurring, and
wherein said base is in the form of a cup adapted for mounting in the opening in the first member, said cup has a flange engageable with the portion of the first member adjacent the opening in the first member, said cup has a tub portion, said tub portion has a slot, and the keeper passes through said slot such that the keeper can be engaged by said sliding member to thereby provide for movement of the first member toward the secured position of the first member in the direction substantially parallel to the direction in which said sliding member moves relative to said base as said sliding member moves toward said closed position of said sliding member relative to said base when said base is mounted to the first member.

15. The latch according to claim 14, wherein the latch is for use with the keeper that has at least a portion that is in the form of a post, and wherein said sliding member has an opening adapted to receive the post,
when the latch is mounted to the first member and the first member is positioned relative to the second member such that the post passes through said slot in said tub portion of said cup and the first member is ready for movement into the secured position thereof.

16. The latch according to claim 15, wherein said first linking member has a pair of closed detent legs that at least help to retain the latch in a closed configuration until the latch is forced to an open configuration by a user.

17. The latch according to claim 16, wherein each of said pair of closed detent legs is resilient and has a tip and a detent projection provided within proximity of said tip.

18. The latch according to claim 17, wherein said sliding member has a pair of catch surfaces and said detent projection of each of said pair of closed detent legs engages a respective one of said pair of catch surfaces to at least help to retain the latch in said closed configuration until the latch is forced to said open configuration by a user.

19. The latch according to claim 18, wherein each of said pair of catch surfaces is formed by a respective one of a pair of detent slots formed in said sliding member.

20. The latch according to claim 19, wherein said first linking member has a pair of open detent legs that at least help to retain the latch in said open configuration until the latch is forced to said closed configuration by a user.

21. The latch according to claim 20, wherein each of said pair of open detent legs is resilient and has a tip and a detent projection provided within proximity of said tip of each of said pair of open detent legs.

22. The latch according to claim 21, wherein said sliding member has a pair of open detent surfaces and said detent projection of each of said pair of open detent legs engages a respective one of said pair of open detent surfaces to at least help to retain the latch in said open configuration until the latch is forced to said closed configuration by a user.

23. The latch according to claim 22, wherein said first linking member has a middle portion and said third pivotal connection is located within proximity of said middle portion of said first linking member and said first linking member serves as a handle to allow a user to operate the latch.

24. The latch according to claim 23, wherein said means for securing said base to the first member comprises a retainer pivotally supported relative to said cup, said retainer being movable between fastened and unfastened positions, said retainer and said flange cooperatively maintaining the portion of the first member adjacent the opening in the first member intermediate said retainer and said flange to thereby maintain said cup in a mounted position relative to the opening in the first member when said cup is in the mounted position and said retainer is in said fastened position.

25. The latch according to claim 24, further comprising means for maintaining said retainer in said fastened position.

26. The latch according to claim 25, wherein said retainer is a resilient frame-like structure pivotally linked to said cup.

27. The latch according to claim 26, wherein said cup has at least a pair of slots and said retainer has at least a pair of opposing projecting portions that engage respective ones of said at least a pair of slots to retain said retainer in said fastened position, said means for maintaining said retainer in said fastened position comprising said at least a pair of slots.

28. The latch according to claim 27, wherein each of said at least a pair of opposing projecting portions is approximately U-shaped.

29. The latch according to claim 27, further comprising:
an operating mechanism supported by said cup, said operating mechanism including a sliding member slidably movable relative to said cup,
wherein said pair of opposing projecting portions extend through said at least a pair of slots and at least in part help to guide said sliding member as said sliding member slidably moves relative to said cup.

30. The latch according to claim 29, wherein said retainer is formed by a wire having bends at various locations along its length to thereby form said resilient frame-like structure.

31. The latch according to claim 30, wherein said retainer has at least a third projecting portion that extends toward said flange when said retainer is in said fastened position, said third projecting portion engaging the first member and cooperating at least in part with said flange to maintain the portion of the first member adjacent the opening in the first member intermediate said retainer and said flange to thereby maintain said cup in a mounted position relative to the opening in the first member when said cup is in the mounted position and said retainer is in said fastened position.

32. The latch according to claim 31, wherein said third projecting portion is formed by an approximately V-shaped bend in said retainer.

33. The latch according to claim 26, wherein the latch can be used with the first member that has a slot provided proximate the opening in the first member, and wherein said retainer has at least one projecting portion adapted to engage the slot proximate the opening in the first member to retain said retainer in said fastened position, said means for maintaining said retainer in said fastened position comprising said at least said projecting portion.

34. The latch according to claim 33, wherein said retainer pivots about a pivot axis and said projecting portion is approximately V-shaped and projects toward said pivot axis.

35. A latch for use in securing a first member in a secured position, the first member having an opening for mounting the latch thereto, the latch comprising:
a cup adapted for mounting in the opening in the first member, said cup having a flange engageable with a portion of the first member adjacent the opening in the first member, said cup having at least one lateral slot;
an operating mechanism supported by said cup, said operating mechanism being operable between closed and open configurations, said operating mechanism including a projection that moves along said lateral slot as said operating mechanism is operated between said closed and open configurations; and
a retainer adapted to be secured in a fastened position relative to said cup, said retainer and said flange cooperatively maintaining the portion of the first member adjacent the opening in the first member intermediate said retainer and said flange to thereby maintain said cup in a mounted position relative to the opening in the first member when said cup is in the mounted position and said retainer is in said fastened position,
wherein said projection engages a portion of the portion of the first member adjacent the opening in the first member to maintain said cup in the mounted position relative to the opening in the first member sliding member when said operating mechanism is in said closed configuration to thereby maintain said cup in the mounted position relative to the opening in the first member during installation of said cup to the first member.

36. The latch according to claim 35, wherein said retainer is pivotally supported relative to said cup, wherein said retainer is a resilient frame-like structure pivotally linked to said cup, wherein said cup has at least one retainer fastening slot, and wherein said retainer has at least one projecting portion that engages said at least one retainer fastening slot to retain said retainer in said fastened position when said cup is mounted to the first member.

37. The latch according to claim 36, wherein said operating mechanism further comprises:
a sliding member movably supported by said cup, said sliding member being slidably movable relative to said cup over a range of motion between open and closed positions;
a first linking member pivotally connected to said cup at a first pivotal connection, said first linking member being pivotally movable between open and closed positions; and
a second linking member pivotally connected to said sliding member at a second pivotal connection, said second linking member being pivotally connected to said first linking member at a third pivotal connection, said second linking member being pivotally movable relative to said sliding member between open and closed positions,
wherein said sliding member moves over at least a portion of said range of motion toward said closed position of said sliding member relative to said cup responsive to movement of said first and second linking members toward their respective closed positions, and
wherein the first member moves toward a secured position in a direction substantially parallel to a direction in which said sliding member moves relative to said cup as said sliding member moves toward said closed position of said sliding member relative to said cup when said cup is mounted to the first member.

38. The latch according to claim 37, wherein the latch is for use in securing the first member in the secured position relative to a second member having a keeper provided in a fixed positional relationship relative to the second member, and wherein said sliding member is adapted for being positioned substantially in a secured position relative to the keeper even as said sliding member moves toward said closed position of said sliding member relative to said cup responsive to movement of said first and second linking members toward their respective closed positions and even as movement of the first member toward the secured position thereof is occurring.

39. The latch according to claim 38, wherein said cup has a tub portion, said tub portion has a keeper slot, and the keeper passes through said keeper slot such that the keeper can be engaged by said sliding member to thereby provide for movement of the first member toward the secured position of the first member in the direction substantially parallel to the direction in which said sliding member moves relative to said cup as said sliding member moves toward said closed position of said sliding member relative to said cup when said cup is mounted to the first member.

40. The latch according to claim 39, wherein the latch is for use with the keeper having at least a portion that is in the form of a post, and wherein said sliding member has an opening adapted to receive the post,
when the latch is mounted to the first member and the first member is positioned relative to the second member such that the post passes through said keeper slot in said tub portion of said cup and the first member is ready for movement into the secured position thereof.

41. A panel having an opening adapted to receive a cup of a latch for mounting of the latch to the panel, the panel having an exterior and a back, the panel comprising:
a plurality of tabs projecting from said back of the panel proximate said opening in the panel; and
at least one slotted tab projecting from said back of the panel proximate said opening in the panel.

42. The panel according to claim 41, wherein said plurality of tabs are positioned adjacent the opening and contact the cup of the latch to thereby provide a larger supporting surface for the cup of the latch when the latch is mounted to the panel.

43. The panel according to claim 42, wherein said slotted tab has a slot adapted for engagement by a resilient retainer pivotally connected to the cup of the latch.

44. The panel according to claim 43, wherein said opening has a first portion having a first width and a second portion having a second width, said second width being larger than said first width.

45. The panel according to claim 44, wherein said opening is formed in a depression in the panel.
